(19) United States
(12) Patent Application Publication
(10) Pub. No.: US 2012/0260188 A1
(43) Pub. Date: Oct. 11, 2012

(54) POTENTIAL COMMUNICATION RECIPIENT PREDICTION

(75) Inventors: Seung-Hae Park, Seattle, WA (US); Suraj Samaranayake, Seattle, WA (US); Arcadiy Gregory Kantor, Seattle, WA (US); Sarah Filman, Seattle, WA (US); Omar H. Shahine, Seattle, WA (US); Piero Sierra, Seattle, WA (US); Stephen Liffick, Seattle, WA (US); Anthony Frey, Seattle, WA (US); Siddhartha Parmar, Seattle, WA (US)

(73) Assignee: Microsoft Corporation, Redmond, WA (US)

(21) Appl. No.: 13/080,778

(22) Filed: Apr. 6, 2011

(51) Int. Cl. G06F 3/048; G06F 17/30

(52) U.S. Cl. 715/739; 707/776; 707/E17.014

(57) ABSTRACT

One or more techniques and/or systems are provided for identifying potential recipients for a communication (e.g., email, instant message, content sharing platform, etc.) a user is presently preparing based at least in part upon a user's communication history. That is, information about the user's interactions with past recipients of his/her communications are compared with information known about the present communication and potential recipients of the present communication are identified based upon this comparison. Moreover, in one embodiment, based upon the past interactions of the user with others, one or more communication groups can be identified and presented to the user. In this way, a user may select a communication group and recipients included in the communication group can be added as recipients for the communication the user is presently preparing without the user having to manually create such groups, for example.

### BACKGROUND

Today, e-mail and other computer generated communications are commonly used for both business and personal purposes to convey messages, documents, pictures, etc. from a sender to one or more recipients. Recipients that a sender frequently corresponds with are commonly stored in an electronic address book, and when a sender composes a new email, instant message, etc., the sender selects one or more recipients for the new email, instant message, etc. from the electronic address book. To select the recipients, the sender either scrolls through the address book to identify the desired entry(ies) and/or the sender begins to input the recipient's name, email address, and/or other user specific information in a recipient field (e.g., a “To” field, “CC” field, etc.), for example. A list of potential recipients matching the sender inputted information (e.g., where respective potential recipients' names begin with the characters the user has inputted) is determined and presented to the sender for selection. Thus, a list of potential recipients is presented to a user, where the potential recipients that make up the list are determined based upon a correspondence between a potential recipient's name or email address, for example, and the user inputted characters.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for identifying one or more potential recipients for a communication the user is presently or currently preparing based upon a user's (e.g., sender's) history (e.g., past correspondence) with past recipients of the user's communications are provided. These potential recipients may, in one embodiment, include past recipients that have been ranked (e.g., automatically) based upon predefined relevance guidelines. For example, in addition to and/or in substitution for a ranking based upon a correspondence between the past recipient's name and the user inputted character(s), the relevance of respective past recipients (e.g., and thus the determination about whether to include a particular past recipient in the potential recipient list) may be based at least in part on the frequency of communications between the user and the past recipient, how recently the user and the past recipient have communicated, and/or the types of communications between the user and the past recipient. For example, holding all else constant, a list of potential recipients may include a particular past recipient if the communication being prepared includes an image attachment but may not include the particular past recipient if the communication being prepared includes a document attachment or no attachment at all if the user typically sends image files to the particular past recipient but rarely, if ever, otherwise sends a communication to the past recipient. Thus, in one example, the relevance of respective potential recipients is determined based at least in part upon past communications between the user and past recipients and the type of (e.g., content of the) communication the user is currently preparing.

Moreover, in one embodiment, a communication group can be automatically created based upon the user's past history of communication with two or more past recipients. For example, if the user frequently composes emails that respectively include the names of six recipients, a communication group, comprising the six recipients' email addresses, may be automatically created. Thus, as the user is preparing the current email or a future email, the user may select a single communication group listing all six recipients as opposed to selecting the six recipients individually, for example.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an exemplary system for identifying one or more potential recipients of a communication a user is presently preparing.

FIG. 2 is an exemplary graphical user interface for presenting a grouping of potential recipients to a user.

FIG. 3 is an exemplary graphical user interface for presenting a grouping of potential recipients to a user.

FIG. 4 is an exemplary electronic address book of a user.

FIG. 5 is an exemplary group of entities that may be reviewed to identify potential recipients of a communication a user is presently preparing.

FIG. 6 is a flow chart illustrating an exemplary method for identifying one or more potential recipients of a communication a user is presently preparing.

FIG. 7 is an illustration of an exemplary computer-readable medium wherein processor-executable instructions configured to embody one or more of the provisions set forth herein may be comprised.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Presently, autocomplete features, such as those commonly found in email applications, provide suggestions (e.g., such as suggestions for email recipients) based upon the characters that a user has typed into the given field. For example, if a user were to type the characters “Da” into a recipient field, the user may be presented with a list of potential recipients whose names and/or email addresses begin with the characters “Da” (e.g., Dave, Darren, etc.). While such a tool is useful, its applicability is limited. For example, suggestions generally do not appear until the user begins to enter characters into the field, and the suggestions are based upon the characters that the user has typed. Thus, few, if any, suggestions appear before the user inputs a sufficient number of characters (e.g., one or more characters) into an input field. Moreover, the suggestions that appear once a user has inputted characters are generally based on a correspondence (e.g., match) between the user inputted characters and respective contacts' names and/or email addresses (e.g., as stored in an electronic address book). That is, it is believed that little if any other information such as the type(s) of communication(s) between the user and past recipients is considered in determining whether past recipients should be suggested to the user (e.g., as potential recipients) for incorporation into the communication the user is presently or currently preparing. Stated differently, one or more relationships between the user and the one or more past recipients and/or between two or more past recipients are not taken into account when surfacing recipient suggestions (e.g., before a user has inputted characters and/or after a user has inputted characters) for a communication the user is presently preparing.

Further, to create a communication group, also at times referred to herein as contact group, ad-hoc group, and/or the like, the user presently has to manually create the group by creating a group name and selecting users to be included in that group. For example, to create a company-wide distribution lists, a user generally creates a group name (e.g., that will appear in the company directory), and specifies which employees are to be included in that distribution list. In this way, employees that wish to send emails to multiple people (e.g., the entire company) can merely select the group, as opposed to selecting respective recipients individually. While these communication groups are useful (e.g., particularly if the email is being sent to tens or hundreds of people), it is manually intensive to create them because of the amount of data entry that is required. Moreover, because they are manually intensive to create, users often times will not go through the process to create them, particularly if the group of recipients consists of fewer than 10 people, for example. Thus, techniques and/or systems for the auto-creation or auto-population of one or more communications groups and/or individuals would be useful and are provided herein. That is, presently, auto-suggest merely suggest recipients one at a time and/or suggest a communication group that the user has actively created (e.g., by selecting recipients to be included in the group). Techniques and/or system for automatically creating communication groups and auto-suggesting such groups would be useful and are provided herein. In this way, auto-suggest can suggest multiple recipients for a communication at once without a user having to actively create a group that includes the multiple recipients, for example.

As described herein, one or more systems and/or techniques for correcting the aforementioned and other deficiencies are provided herein. For example, as will be described in more detail below, systems and techniques are described for storing information related to a user's past communication with one or more recipients of the past communication. Such information may be used for a multitude of purposes. For example, in one embodiment, based upon the user's communication history, potential recipients for a communication the user is presently preparing can be identified and presented to the user. Moreover, in another embodiment, the user's communication history can be used to identify one or more communication groups. Moreover, it will be appreciated that in some embodiments, the user's history and/or the information derived from that history (e.g., the potential recipient(s), the communication group(s), etc.) can be available across devices (e.g., personal computers, mobile devices, etc.) and/or applications (e.g., a desktop email client, a web client, etc.).

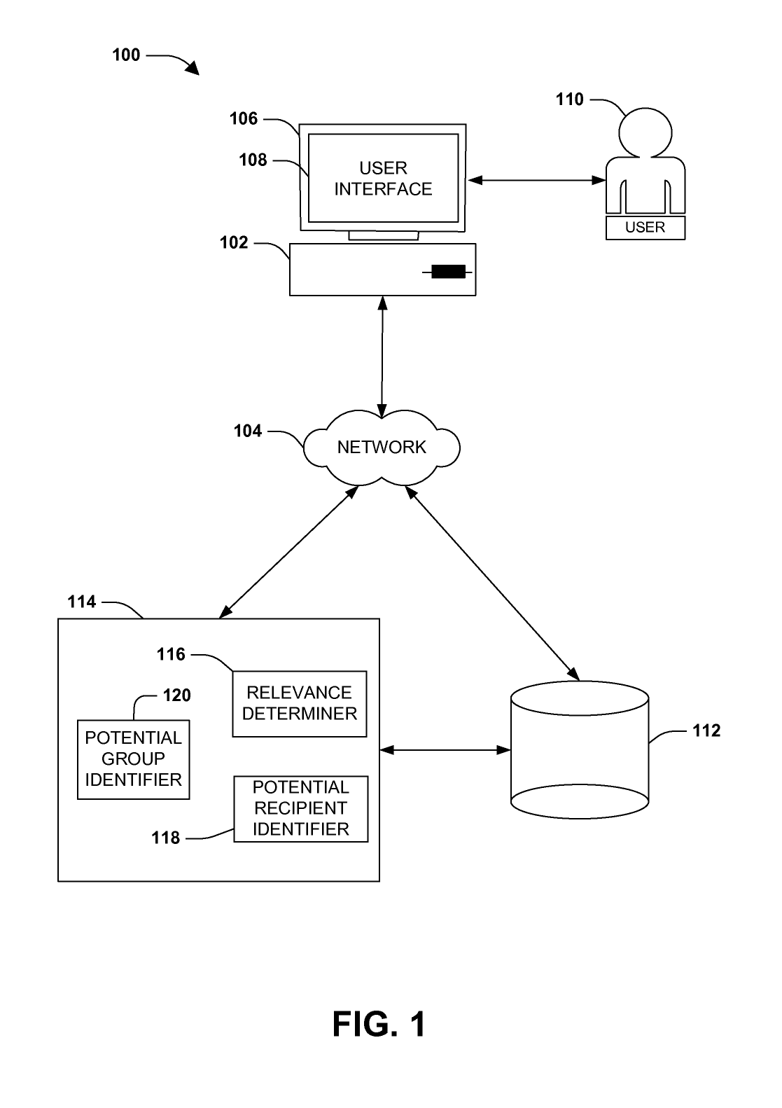

FIG. 1 illustrates one example system 100 for identifying potential recipients (e.g., of an electronic communication) and/or for creating one or more communications groups based upon a user's communication history (e.g., based upon past emails that have been sent by the user and/or to the user). It will be appreciated that the example system 100 is merely one example configuration of a system configured to perform the actions described herein, and other configurations are also contemplated.

The example system comprises a first computing device 102 (e.g., a laptop, desktop computer, tablet, mobile device, etc.) that is operably coupled to a network 104 (e.g., a cluster of one or more additional computing devices) via a network interface (e.g., Ethernet card, modem, wireless card, etc.). The first computing device 102 is configured to receive input from a user 110, such as through a keyboard and/or mouse, for example that is operably coupled to the first computing device 102. The first computing system 102 further comprises a display 106 (e.g., a computer monitor), that is configured to display one or more user interfaces 108 to the user 110. Moreover, in one embodiment, the display 106 may comprise a touchscreen and the first computing device 102 may be configured to receive user input through the display 106, for example.

Using the first computing device 102, the user 110 may prepare electronic communications directed to one or more recipients (e.g., which may be transmitted through the network 104). For example, the user 110 may, among other things, compose emails, initiate instant messages, participate in video conferences, and/or send faxes. Additionally, the electronic communication may comprise a web posting or other posting accessible by intended recipients. Such a posting may comprise one or more documents and/or photos, etc., for example, and the user may limit access to the posting by specifying the entities (e.g., recipients) that are allowed to view and/or modified the posting, for example. In this way, a user can share a document with one or more recipients without actively sending the document to the recipients, for example. Thus, the terms electronic communication, user communication, and/or the like are used herein in a broad sense to include techniques and/or systems that provide a means for sharing content between two or more entities.

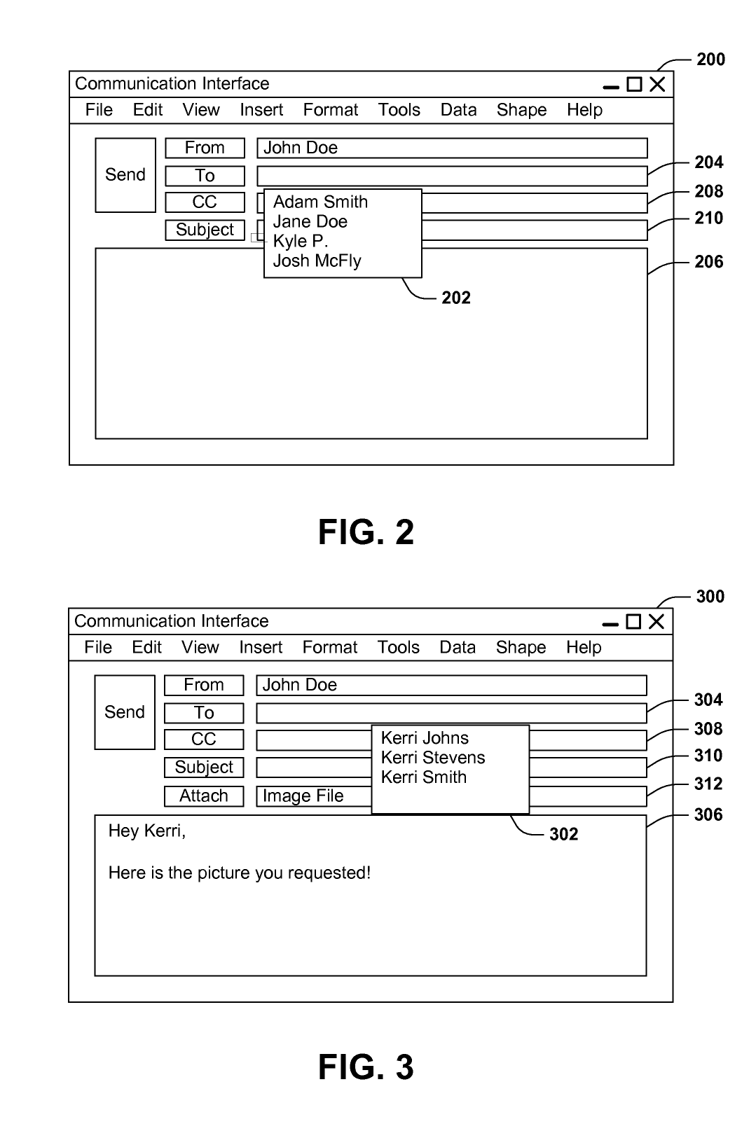

As illustrated herein and described in more detail with respect to FIGS. 2-3, the first computing device 102 is configured to display one or more user interfaces 108 on the display 106 to the user 110. At least some of these user interfaces 108 comprise fields for initiating and/or continuing communications with one or more other entities (e.g., generally referred to herein as potential recipients and/or contacts). For example, in one embodiment, an email application is stored on the first computing device 102 (e.g., a client-side application), and when the application is launched, a user interface 108 for the email application may be presented to the user 110. In such an embodiment, using the interface 108, the user 110 may prepare an email that may be sent to one or more recipients (e.g., as specified in a “To,” “CC,” or “BCC” field), for example. In another embodiment, the user 110 may access a web-based email application, instant messaging application, video-conferencing application, etc. using a standard internet browser, for example, and the application's interface may be displayed to the user 110 within the internet browser, for example. Thus, the application used to compose the communication and/or initiate the communication may be a client-side application and/or non-client side (e.g., a web-based) application, for example.

As an example, in one embodiment, the first computing device 102 comprises a client-side email application. A user interface 108 of the client-side email application is configured to be displayed to the user 110 on the display 106, and through the user interface 108, the user 110 can, among other things, compose email and select and/or input one or more recipients of the email. For example, a list of potential recipients may be displayed to the user 110 within the user interface and/or in a separate user interface (e.g., associated with the same and/or a different application, such as an electronic address book that is not part of the client-side email application) and the user 110 may select one or more recipients from the presented list or group. Once the communication has been composed and recipients have been selected, the communication may be sent to the recipients via a communication interface of the first computing device 102, for example (e.g., and transmitted through the network 104 to a computing device associated with the recipient), or in the case of a web posting, for example, the communication (e.g., document, picture, etc.) may be posted, with the recipients (but not others) having permissions to read and/or modify the posting, for example.

The example system further comprises a database 112 that is operably coupled to the network 104 and is configured to store information related to the communication history of the user 110. For example, the database may comprise at least portions of past electronic communications of the user and/or may include specified features regarding the communications (e.g., recipients of respective communications, topics discussed in the communication, when the user last communicated with respective recipients, whether one or more attachments were included, etc.).

The contents of the database may vary according to the application and/or implementation details, for example. In one example, the data merely comprises information related to the recipients of respective communications and keywords that describe the type of content comprised in respective communications. That is, the database 112 may be populated with the recipient(s) name and/or unique identifier (e.g., email address, screen name, etc.) and basic information describing the communication (e.g., based upon keywords in the communication, whether an attachment was included, the type of attachment included, etc.), for example. In another example, the database 112 comprises respective communications substantially in their entirety and the communications are cross-referenced with a list of contacts (e.g., such that respective contacts are linked with the communications to which they were a party). It will be appreciated that the arrangement of the database 112 and the specific contents of the past communications and/or the information derived from the past communications that are saved to the database 112 may vary and thus the aforementioned examples are merely intended to provide some example techniques for populating the database. The instant application, including the scope of the claims, is not intended to be so limited. That is, the information comprised in the database 112 and the arrangement of that information/data may vary from that described herein.

The database 112 may be populated with information from a variety of applications and/or platforms. For example, the user's history, as stored in the database 112, may comprise information acquired from email communications, instant message communications, communications made in social networking applications, etc. Moreover, it will be appreciated that in one embodiment, this information may be acquired from one or more sources. For example, a portion of the information may be acquired from communications created on a client computer (e.g., and saved on the client computer) while other information may be acquired from communications created on a mobile device, such as from text messages transmitted from the mobile device. Thus, the information related to the user's communication history can be aggregated from one or more sources and/or one or more applications (e.g., text messaging applications, email applications, instant messaging applications, etc.) to create a general profile, for example, of the user's communication history with respective past recipients.

The example system 100 also comprises a suggestion engine 114 that is operably coupled to the network 104 (e.g., that is hosted by a second computing device). The suggestion engine 114 is configured to provide potential recipient suggestions to the user (e.g., via the user interface 108). That is, as the user 110 is preparing a new communication and/or before the user 110 actually begins to input information into the communication (e.g., such as the names of recipients), the suggestion engine 114 is configured to identify one or more potential recipients (e.g., also referred to as contact suggestions) based at least in part on the user's communication history that is derived from the information stored in the database 112. While the identification of potential recipients may consider (or may not consider) user input into a recipient field (e.g., a “To” field, “CC” field, etc.) as a criteria for the identification, the identification is generally based on something other than a match between one or more characters inputted by a user and one or more corresponding characters of respective potential recipient's names and/or unique identifiers, for example. Stated differently, the suggestion engine 114 identifies relevant contacts based at least in part on something other than a correspondence between user input into a recipient field (e.g., a “To” field, “CC” field, “BCC” field) and characters of respective contacts name and/or unique identifier (e.g., email address, screen name, etc.).

As illustrated in the example system 100, the suggestion engine 114 may comprise one or more components configured to assist in the identification of potential recipients of the communication the user is presently preparing. For example, among other things, the example suggestion engine 114 comprises a relevance determiner 116 configured to identify relevant features of the communication the user is presently preparing based at least in part on information known about the communication. For example, relevant features may be determined by the relevance determiner 116 based upon the means of communication (e.g., whether the communication is an email, instant message, etc.), the source of the communication (e.g., whether the communication is being prepared on a cellular telephone, laptop) and/or the information the user 110 has entered into the communication. For example, if the user has inserted an attachment in the communication, the relevance determiner 116 may determine that such an attachment is relevant to the identification of potential recipients. Moreover, if the user has prepared the message, but not yet selected/inputted recipients, in one embodiment, the relevance determiner 116 may parse the message to identify one or more keywords that may be relevant to identifying potential recipients. Thus, the relevance determiner 116 uses the information available regarding the communication being prepared to identify relevant features about the communication that may assist in the identification and/or ranking of potential recipients of the communication.

Moreover, in one embodiment, the relevance determiner 116 is further configured to weigh the relevant features of the communication based upon some predetermined criteria. In this way, respective, relevant features are given more or less weight in the identification/ranking of potential recipients. For example, characters the user has inputted into a recipient field and/or keywords identified in the content of the communication may be given more weight than the source of the communication (e.g., on what type of device the user is preparing the communication) and/or the means of the communication. In this way, features that are considered to be more relevant in making a determination/ranking about potential recipients are given more weight while features that are less relevant (e.g., or more generic) are given less weight.

The example suggestion engine 114 further comprises a potential recipient identifier 118 configured to identify one or more potential recipients based upon the features identified by the relevance determiner 116 and/or information about the past communication history of the user as stored in the database 112. Stated differently, the potential recipient identifier 118 is configured to compare the communication the user is currently preparing with the information related to the user's interactions with one or more past recipients of the user's communications to identify one or more potential recipients of the user's current communication. For example, the potential recipient identifier 118 may be configured to compare a type of communication currently being prepared (e.g., as derived from the relevant features such as keywords in the body of the communication, the number of and/or types of attachments included in the communication, the origin of the communication (e.g., if the user is preparing the communication on a work device or a personal device), etc.) with the information related to the types of communications the user frequently has with respective past recipients in the database 112 to identify one or more potential recipients. That is, using the features identified by the relevance determiner 116, the potential recipient identifier 118 may be configured to identify a type of email, for example, the user 110 is composing and identify to whom similar emails have been sent in the past. Thus, in one example, if the user 110 has attached a picture file to the communication currently being prepared, for example, the relevance determiner 116 may identify such an attachment as relevant, and the potential recipient identifier 118 may determine that the communication is related to pictures. Contacts or past recipients to whom the user has previously sent pictures may be identified as potential recipients (e.g., to the exclusion of other past recipients in database 112).

It will be appreciated that in one embodiment, the potential recipient identifier 118 may consider other information (e.g., besides what is presented to it by the relevance determiner 116) when identifying potential recipients and/or when ranking potential recipients (e.g., if the potential recipients are ranked to create a list). For example, the potential recipient identifier 118 may consider the frequency of communication between respective past recipients and the user 110 and/or may consider how recently the two have communicated, which may be determined based upon the communication history of the user (e.g., as stored in the database 112). Thus, the potential recipient identifier 118 may consider numerous factors from a plurality of sources to identify potential recipients and/or to rank the identified, potential recipients. Moreover, it will be appreciated that if the relevance determiner 116 determines that no features of the current communication are relevant to determining potential recipients, the potential recipient identifier 118 may identify/rank potential recipients based merely upon the user's history (e.g., based upon the frequency of contact with respective contacts, how recently the user 110 and respective contact have communicated, etc.). Thus, the potential recipient identifier 118 may identify potential recipients even when no characters have been input by the user 110 and/or when the information about the communication that is being prepared is too vague to ascertain meaningful features (e.g., such that the relevance determiner 116 identifies few if any relevant features), for example.

It will be appreciated that the relevance of potential recipients (and thus the identified, potential recipients) may change based upon changes made to the communication (e.g., text the user 110 has inserted into the body of the communication, characters the user has inputted into a “to” field, etc.), and thus, in one embodiment, the suggestion engine 114 and/or the relevance determiner 116, for example, parse the communication in real-time to identify changes in the communication. In another embodiment, information regarding the changes is automatically sent to the suggestion engine 114 via the network 104 from the first computing device 102, for example. In yet another embodiment, the information regarding the communication is not received in real-time as the user 110 is composing the communication. Rather, the relevance determiner 116 identifies relevant features at predetermined internals (e.g., when a predefined time has elapsed and/or when a specified action has occurred).

In one embodiment, where the potential recipients are presented to the user 110 as a list, for example, the potential recipient identifier 118 is further configured to rank the potential recipients based upon features identified by the relevance determiner 116 and/or information about respective recipients that is stored in the database 112 (e.g., the potential recipient that the user 110 has more recently communicated with may appear at the top of the list).

After potential recipients have been identified by the potential recipient identifier 118 and, optionally, ranked, the suggestion engine 114 may be configured to transmit the grouping or list through the network 104 to the first computing device 102, and the grouping/list may be displayed to the user 110 via the user interface 108. In this way, the user 110 may select potential recipients from the list, or other grouping, to be included in a recipient list for the communication, for example. It will be appreciated to those skilled in the art that the actions of the user (e.g., which recipients from the identified potential recipients are selected by the user and which are not) may be stored (e.g., in the database 112) and used as input for future potential recipient identifications. For example, a name presented as a potential recipient in a present communication, but not selected by the user, may not be presented as a potential recipient in a future communication comprising substantially similar content because the user did not select the potential recipient as a recipient for the present communication (e.g., the relevance of the potential recipient has decreased because the user did not select the potential recipient as a recipient for the present communication).

In additional to identifying potential recipients, the suggestion engine 114 may further suggest one or more groups of recipients (which may or may not be stored as a group entry in a user's electronic address book) based upon the communication history of the user. For example, in one embodiment, the suggestion engine 114 comprises a potential group identifier 120 configured to identify a potential communication group (e.g., associated with two or more past recipients) based upon the communication history of the user 112. Stated differently, the potential group identifier 120 is configured to identify one or more communication groups based upon the user's previous interactions with past recipients of the user's communications. For example, if the user 110 were to frequently email several recipients collectively, the potential group identifier 120 may identify that a group exists even if the user 110 does not go through the actions of actually creating a group in his/her electronic address book. Such a communication group may then be presented to the user 110 in the potential recipient list/grouping, for example.

Moreover, it will be appreciated that if the user 110 begins to input the name and/or unique identifier of one or more of the recipients in an identified communication group, the user 110 may be presented with an option to select the recipient matching the inputted characters and/or the communication group(s) to which the recipient belongs. Thus, for example, if the user 110 were to input the name “John” in a recipient field, the user 110 may be presented with a potential recipient list that includes not only the email address for John, for example, but also with one or more communication groups to which John has been associated (e.g., even though the user 110 never created those communication groups in an electronic address book, for example). In this way, instead of the user 110 manual entering the name of respective recipients individually (e.g., as is presently done) if a communication group has not been created, the user 110 may be presented with the option of selecting a communication group comprising all or substantially all of the recipients to which the user had intended to enter one-by-one.

It will be appreciated that the example system 100 is merely an example embodiment for implementing the features herein described, and other embodiments are also contemplated. For example, as illustrated, the suggestion engine 114 and/or the database 112 is not part of the first computing device 102 but rather is operably coupled to the first computing device 102 via a network 104 (e.g., the suggestion engine 114 and/or the database 112 are part of a second computing device). However, in another embodiment, the suggestion engine 114 (e.g., and the components thereof) and/or the database 112 may be part of the first computing device 102.

Moreover, it will be appreciated that while the example system illustrates that suggestion engine 114 and/or database 112 being operably coupled to merely a first computing device 102, the suggestion engine 114 and/or database 112 may be operably coupled to a plurality of the user's devices. Thus, for example, the suggestion engine 114 may deliver potential recipients to a desktop computer, mobile device, and/or tablet. To promote security and/or protect the user's past communication history, in one embodiment, the user and/or the user's device is authenticated (e.g., via a user login identification and password and/or other authentication tool). Additionally, the suggestions may be delivered across platforms. Thus, for example, suggestions may be delivered to and/or a communication history of a user may be derived from client-side applications and/or web-based applications, for example. That is, for example, information regarding the users past activities with an online sharing database may be used to help determine the relevance of a potential recipient of an email communication the user is presently preparing and/or vice-versa, for example. Moreover, at least some of the suggestion engine 114 and/or the database 112 may be stored locally on more than one device where the devices can communicate and/or interoperate, such as across a network, for example.

FIG. 2 illustrates an example embodiment of a graphical user interface 200 (e.g., 108 in FIG. 1) comprising a potential recipient field 202 for presenting potential recipients (e.g., as identified by the suggestion engine 114 in FIG. 1), which may be selected by a user for incorporation into the “To” field 204, for example. It will be appreciated that such a field 202 may be displayed upon the initiation of the application and/or upon the selection to create a new communication. That is, such a field may (or may not) be displayed before the user inputs any information into the communication itself, such as a subject line, an attachment, characters of the recipient's name or unique identification, and/or information into the body 206 of the communication, for example.

As described above, the potential recipients that are comprised in the potential recipient field 202 are identified based at least in part upon something other than a match, or correspondence, between one or more characters inputted by a user and one or more corresponding characters of past recipients of the user's communications. That is, the list or grouping of potential recipients are not merely (but can be partially) identified based upon characters the user has entered into the “To” filed 204, for example. It will be appreciated that in this example illustration, the user has not entered any characters into the “To” field, or for that matter the user hasn't provided any input into the communication, and thus the potential recipients cannot be identified based upon user input. Rather, the potential recipients may be identified based upon the application that is being used to prepare the communication (e.g., whether it is an email application, an instant message application, etc.), the device being used to prepare the communication (e.g., whether the device is a work computer, personal computer, mobile phone, etc.), the frequency of contact between respective past recipients and the user (e.g., the 4 past recipients that user contacts most may be displayed), and/or how recently the user and respective past recipients last communicated (e.g., the 4 past recipients that the user most recently contacted may be displayed).

The user, may, at his/her option select one or more potential recipients from the potential recipient field 202 and the potential recipient, or an address corresponding to the recipient, such as the potential recipient's email address, for example, may be added to the “To” field or another recipient field, such as the “CC” field 208, for example (e.g., making the potential recipient an actual recipient of the communication). If the user elects not to make a selection of one or more of the potential recipients, that user may proceed with entering other information into the communication. For example, the user may enter characters into the “To” field 204 and the potential recipient field 202 may be updated based upon a change in the relevance of potential recipients. For example, if the user entered the characters “Da” into the “To” field, names and/or unique identifiers (e.g., email addresses, screen names, etc.) that begin with the characters “Da” may be identified as more relevant, relative to other potential recipients, and thus the potential recipient field 202 may be updated to comprise the names of one or more potential recipients whose names are associated with the characters “Da.”

In another embodiment, the potential recipient field 202 may be updated based upon information inserted elsewhere in the communication (e.g., besides in a recipient field). For example, the user may ignore the potential recipient field 202 when it is first displayed and may proceed to input a subject for the communication in a subject field 210, may proceed to attach a file to the communication, and/or may proceed to input information into the body of the communication 206. In response to such input and/or actions, the potential recipient field may be updated (e.g., to comprise a different list of potential recipients). Stated differently, as the user inputs information into the communication (e.g., regardless of where the input occurs and/or the type of input), a better prediction can be made about who the user is likely to send this communication to and, based upon the improved prediction, a potential recipient field 202 can be updated to reflect a prediction of the potential recipients.

It will be appreciated that the potential recipient field 202 can be updated in real-time (e.g., as the user input is being received) and/or it can be updated periodically based upon predefined events (e.g., such as when a predefined time has lapsed since the last update and/or when the user places a cursor into one of the recipient fields 204, 208). Moreover, while the example interface 200 illustrates the potential recipient field 202 as being displayed before user input is received into the communication, in another embodiment, the potential recipient field 202 may not be displayed until some form of user input is received into the communication (e.g., the user attaches a file, the user inputs characters in the body of the communication 206 or in a “To” field 204, etc.). Further, it will also be appreciated that while the example user interface illustrates the potential recipient field as overlaying the communication, in other embodiments, the potential recipient field 202 is situated elsewhere. For example, the potential recipient field 202 may be situated to one or more sides of the communication.

It will also be appreciated that the interface for the potential recipient field 202 may be associated with a different application than the interface for the communication. For example, the interface for the communication may be associated with an email application while the interface for the potential recipient field 202 is associated with an electronic address book application that may or may not be associated with the email application.

FIG. 3 illustrates another example embodiment of a graphical user interface 300 (e.g., similar to the graphical user interface 200 in FIG. 2) comprising a potential recipient field 302 for displaying potential recipients (e.g., as identified by the suggestion engine 114 in FIG. 1), which may be selected by a user for incorporation into a “To” field 304 or another recipient field, such as a “CC” field 308, for example. More specifically, FIG. 3 illustrates a graphical user interface 300 after a file 312 has been attached to the communication and the user has inputted text into the body of the communication 306 (e.g., 206 in FIG. 2).

Based upon the input and/or actions of the user, the potential recipient field 302 is updated (e.g., by the suggestion engine 114 in FIG. 1), to comprise the names and/or unique identifiers of entities that are more relevant to the inputted information as derived from the communication history of the user (e.g., stored in a database 112 in FIG. 1) and/or relevant features of the communication that is being prepared. For example, in the illustration, the user has attached an image file to the communication, has addressed the communication to “Kerri,” and typed the word “picture” in the body of the communication 306. Such features (e.g., keywords, attachments, etc.) may be identified (e.g., by a suggestion engine 114 or a relevance determiner 116 in FIG. 1) and used (e.g., by a potential recipient identifier 118 in FIG. 1) to identify more relevant potential recipients to display in the potential recipient field 302 (e.g., relative to those recipients displayed in the potential recipient field 202 in FIG. 2 before user input into the communication had been received).

It will be appreciated the potential recipients that are displayed in the potential recipient field 302 may change if any one of the features that caused them to originally be displayed changes. For example, if the user had attached a text file instead of an image file, a different list of potential recipients may be presented in the potential recipient field 302 because the user may send image files to one or more of the listed recipients but may not send text files to one or more of the listed recipients. Thus, the names and/or unique identifications that are displayed in the potential recipient field may or may not depend upon something other than (or in addition to) a name and/or unique identification that appears in the communication. For example, in the illustrated graphical user interface 300, if the name “Kerri” did not appear in the body of the communication 306, the potential recipient list may include the names and/or unique identifiers of entities that do not begin with Kerri and that the user more commonly sends picture files to (e.g., based on the keyword “picture” and the image file attachment) relative to recipients listed in the potential recipient field.

As described with respect to FIG. 1, the communication history of the user may be used for more than merely identifying potential recipients that are included in a user's electronic address book. For example, the identified potential recipients may include the names and/or unique identifications of entities that the user has previously corresponded with. Moreover, in one embodiment, ad-hoc groups (also referred to as communication groups, communication groups, group contacts, and the like) may be identified based upon the communication history of the user (e.g., even if the user has not manually created such a group).

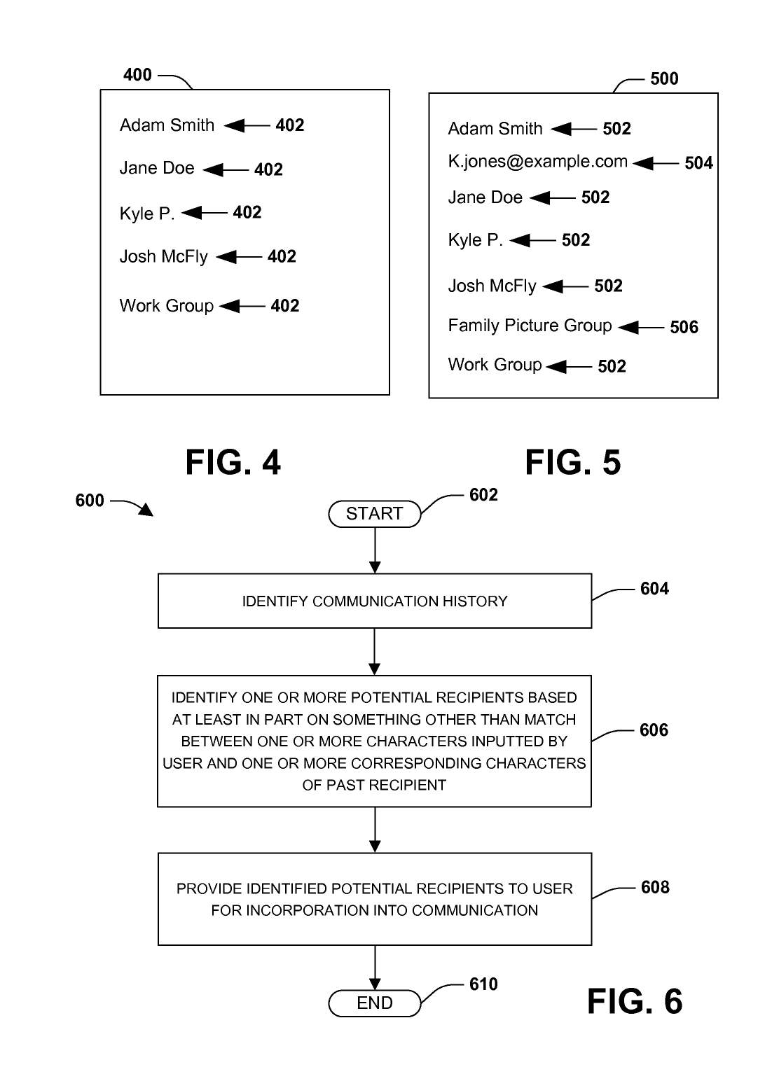

FIG. 4 illustrates an example electronic address book 400 of a user. Generally, respective entries 402 in the electronic address book 400 have been manually inputted and/or saved by the user. For example, the user may open an electronic address book, select an option to create a new entry, and manually input the new entry's name, address, phone number, email address, screen name, etc.

While the electronic address book 400 may serve as a reference point for identifying potential recipients, that list is generally not exhaustive. For example, the user may frequently email another entity, but may not have saved that entity's information as an entry in the electronic address book 400. Thus, a suggestion engine (e.g., 114 in FIG. 1) may identify entities that are not comprised in the electronic address book 400 based upon the communication history of the user.

FIG. 5 illustrates an example list or group of entities 500 that the suggestion engine, or more specifically a potential recipient identifier (e.g., 118 in FIG. 1), for example, may review to identify potential recipients for the communication a user is presently preparing. It will be appreciated that the group of entities 500 may comprise at least some (in this case all) the entries 502 comprised in the user's electronic address book 400 in FIG. 4 and one or more additional entries 504, 506 that are not comprised in the user's electronic address book.

The one or more entries 504, 506 that are not comprised in the user's electronic address book may be derived from the communication history of the user (e.g., as stored in a database 112 in FIG. 1). For example, the entry for an email address 504 may be acquired based upon a previous email the user sent to k.jones@example.com and/or an email that was received from k.jones@example.com. Similarly, the communication group 506 entitled “Family Picture Group” may be an ad-hoc group that may be created automatically in response to (repeated) emails that the user sent to a group of recipients and/or emails received by the user that included a group of recipients. For example, based upon the communication history of the user, a pattern of emails to two or more recipients comprising one or more picture files and the term “family” may be identified and a communication group 506 may be automatically created (e.g., by the potential group identifier 120 in FIG. 1). That is, from the communication history, it may be identified that the user frequently correspond with these same two or more recipients when pictures are attached to the email and the term family is included in the email. Based upon this information, a group entry 506 may be created without the user having to manually create a distribution list, for example. In one embodiment, the user may presented with the option to retain the automatically created group (e.g., and add the entry to his/her electronic address book) or to discard the group.

Moreover, in one embodiment, the name of the group may be determined based upon the topics generally discussed in communications within the group. For example, in the illustrated group of entities 500, the group entry 506 is titled “Family Picture Group,” because the user generally communicates with the group of recipients when a picture file is attached to the communication and when the term “family” is included in the body of the communication. It will be appreciated that other ways of naming the group are also contemplated. For example, the user may be presented with the option of naming the group (e.g., so that the user's name for the group appears in potential recipient groupings) and/or the group name may merely comprise the names and/or unique identifiers of recipient's comprised in the group. That is, for example, rather than providing a name for an (ad-hoc) group, merely mom@example.com, dad@example.com, and sister@example.com, can be presented where it is determined that when communications comprising pictures, for example, have occurred to/from one of these recipients (e.g., mom@example.com), the other two recipients (e.g., dad@example.com and sister@example.com) are included as well. The user may be given the option to name such a group (e.g., where a descriptive name for the group may be difficult to discern automatically).

It will be appreciated that one or more methods for storing the communication history of the user, identifying potential recipients or contact suggestions for a communication that is presently being prepared by the user, and/or displaying a grouping/list of potential recipients to a user for incorporation into the communication are also contemplated herein.

FIG. 6 illustrates one example method 600 for identifying contact suggestions that may be incorporated into a communication of a user. The example method begins at 602, and a communication history of the user is identified and/or stored (e.g., in a database) at 604. The communication history of the user may be derived from one or more sources and/or one or more applications. For example, the communication history may comprise at least portions of the communications that the user had via client-side email applications, web-based email applications, SMS-based messaging (e.g., text messaging), instant messaging applications, video-conferencing applications, etc.

It will be appreciated that the communications may be aggregated into a single database, or may be stored in a multitude of locations. For example, in one embodiment, the communications are stored on whatever source the communication took place. Thus, for example, SMS-based messaging communications that took place via a cellular telephone may be stored by the cellular telephone whereas email communications that took place via a desktop computer may be stored by the desktop computer. Conversely, the communications and/or information derived from the communications may be stored by a database with space dedicated to retaining a user's communication history for the purposes herein described.

It will also be appreciated that the communications themselves may or may not be stored. Rather, in one embodiment, the past communications of the history are merely parsed to identify predefined content (e.g., that has been deemed as relevant for identifying potential recipients), and once the relevant content is identified, the past communications may be discarded. For example, the past communications history may be parsed to identify potential recipients, topics the user and the respective recipients discuss (e.g., derived from keywords in the communication and/or attachments to the communication), how frequently the user and the respective past recipients communicate, how recently the user and the respective past recipients have communicated, etc. In another embodiment, the past communications (e.g., in substantially their entirety) are saved and are used to identify potential recipients.

At 606 one or more potential recipients of a communication the user is presently or currently preparing are identified. The identification is based at least in part on something other than a match between one or more characters inputted by a user and one or more corresponding characters of a potential recipient. That is, while a correspondence between user inputted characters and the name/unique identification of a potential recipient may have some impact on the identification, the identification is not merely based upon such a correspondence. For example, the identification of potential recipients may be based at least in part upon a type of communication the user is preparing, a frequency of communication between the user and respective contacts, and/or how recently the user last communicated with respective contacts. For example, if the user selects to begin a new communication (e.g., but has entered no characters into the communication and/or attached any documents to the communication), the identification of potential recipients may be based merely upon the frequency of communication (e.g., the past recipients that the user communicates with most frequently may be identified as potential recipients) and/or the how recently the user has communicated with respective past recipients (e.g., the past recipients that the user has communicated with most recently may be identified as potential recipients).

It will be appreciated that the identification of potential recipients may be narrowed (e.g., and more accurately predicted) based upon user input into the communication. For example, if the user were to attach a file to the communication, a file type of the attachment could be determined and/or the contents of the attached file could be examined. Based upon such information, a list of potential recipients to which the user has sent a communication(s) comprising a similar attachment may be identified. In this way, a type of communication the user is preparing could be determined and compared with the communication types the user has had with past recipients of his/her communication (e.g., to identify past recipients with which the user has had the type of communication he/she is presently preparing). For example, if the user were to attach a picture to the communication, a different group, or list, of potential recipients may be identified than the group that would be identified if a text file or no file at all were attached to the communication. It will be appreciated that as used herein, the phrase “type of communication” is generally intended to refer to the general contents (e.g. business, pleasure, communication with friends, communication with family, picture mail, etc.) of the communication and not necessarily the medium through which the communication is made (although the medium through which the communication is made may be a consideration for determining a type of communication). For example, a communication for the delivery of a picture may be one type of communication and a communication for the delivery of a text file (e.g., having a specific formatting) may be another, different type of communication.

It will be appreciated that the type of communication may be determined based upon considerations other than and/or in addition to the types of attachments that are included in the communication. For example, if the user is communicating about travel plans, potential recipients to which the user more frequently discusses travel plans may be identified as potential recipients whereas if the user is communicating about a particular business transaction, a different set of one or more potential recipients may be identified. Stated differently, in one embodiment, the set of one or more potential recipients that are identified may be based at least in part upon the type of communication the user is preparing and the frequency with which the user has that particular type of communication (e.g., communicates about that particular topic) with respective recipients. Thus, past recipients with which the user has more commonly had the sort of communication the user is presently preparing (e.g., relative to other past recipients of the user's communications), or past recipients whose communications with the user correspond with the type of communication the user is presently preparing, may be identified as potential recipients for the present communication.

It will be appreciated that other behaviors of the user's past communications may also be analyzed to assist in the identification of potential recipients for the present communication. For example, besides analyzing the past communications to identify to which recipients the user more commonly sends what types of communications, the past communications may be analyzed to identify other patterns in the past communication. For example, the past communications may be analyzed to determine whether the user merely communicated with a past recipient on certain days of the year or week. If the present communication is not occurring on one of those days, then the likelihood that the past recipient is a potential recipient of the present communication decreases, and that particular past recipient may not be identified as a potential recipient for the communication the user is presently preparing. In another example, the past communications may be analyzed to determine the medium of the communication. For example, the user may communicate with a particular set of past recipients merely via SMS-based messaging on a mobile device, and thus if the user is presently preparing an email on a laptop computer, the past recipients with which the user merely communicated via SMS-based messaging may not be identified as potential recipients of the email (e.g., because the probability of the user sending an email to those particular recipients is low). It will be appreciated that the aforementioned behaviors of the user's communication history that may be analyzed are merely intended to be examples of some of the many behaviors that can be analyzed. Those of skill in the art will appreciated that other behaviors that can be identified based upon the communication history of the user are also contemplated herein.

It will also be appreciated that, as described above, the identification of one or more potential recipients at 606 can comprise more than just merely identifying past recipients that are more relevant to present communication (e.g., based upon the factors described above) relative to other past recipients. For example, in one embodiment, the identification can comprise identifying a communication group associated with two or more past recipients based upon one or more common past communications that the user had with the two or more past recipients. Stated differently, a communication group (e.g., a distribution group or list) can be identified based upon the user's communication history, even if the user did not specify that the communication group actually existed (e.g., the user did not link the two or more recipients together to form a group contact). For example, if the user were to commonly send emails relating to a particular work client or work project to multiple individuals collectively (e.g., such that the email addresses of multiple individuals appeared in a recipient field of the email), a communication group may be identified. Moreover, if the user is presently preparing an email relating to that particular work client or work project, the identified communication group may be presented as one of the potential recipients. In this way, the user may merely select the communication group (e.g. and the recipient field may be auto-populated with a plurality of recipients) as opposed to manually entering respective recipients into the recipient field, for example.

Moreover, it will be appreciated that, in one embodiment, a user may be presented with the option to accept the communication group and/or retitle the name of the communication group, if a communication group is identified. If the user accepts and/or retitles the communication group, the group may be stored as a single entry in a user's electronic address book for later identification as a potential recipient in future emails, for example. In this way, communications groups can be created without the user having to manually create the group and associate respective recipients with the group.

It will also be appreciated that because the identification of the potential recipient(s) depends upon more than a correspondence between user input and corresponding characters of a potential recipient, in some circumstances a past recipient may not appear as a potential recipient even if the name of the past recipient corresponds with the characters inputted by the user. For example, suppose an email is determined (e.g., by a relevance determiner 116 in FIG. 1) to pertain to travel. If the user's past communication with a communication group to which the past recipient was a member discussed travel, the communication group may be presented as a potential recipient. However, the name of the past recipient (alone and not as part of the communication group) may not be presented as a potential recipient unless the user and the past recipient communicated by themselves (e.g., apart from the group setting) about travel. Thus, in some situations, a communication group to which a past recipient is a member may be presented as a potential recipient even if the past recipient is not presented as a potential recipient by himself/herself. Further detailing such an example, if the user were to type the name “Dave,” for example, communications groups to which Dave is a member may be presented even if an entry for Dave, individually, is not presented if the one or more communications groups is associated with a communication type or communication topic to which the present email relates, but Dave, individually, is not associated with a communication type or topic to which the present email relates. Similarly, if a communication, for example, is identified as dealing with travel (e.g., based on content of the communication) and characters of “Da” are input into a “To” field of the communication, a previous recipient named Dave may not be presented as a potential recipient if the user has never corresponded with Dave about travel, but Darrel may be presented where the user and Darrel have previously communicated about travel.

At 608 in the example method 600, the identified potential recipients are provided to the user for incorporation into the communication the user is preparing. For example, as illustrated in FIGS. 2-3, the identified potential recipients may be presented to the user via a graphic user interface of an application that is configured to allow the user to prepare the communication. In another example, the identified potential recipients may be presented in a graphic user interface that is part of an application separate from the application that is configured to allow the user to prepare the communication. The user merely selects (e.g., highlights, drags, etc.) one or more of the identified potential recipients, and the selected potential recipient may be incorporated into the communication (e.g., such that, when the user selects to transmit the message, the message is sent to the selected recipient).

It will be appreciated to those skilled in the art that the example method is not intended to be merely limited to a single platform, application, and/or source. For example, the user may be preparing the communication one any of one or more sources (e.g. a personal computer, mobile device, tablet, etc.) and/or preparing the communication using any of one or more applications (e.g. a client-side application, web-based application, email application, instant message application, etc.) and the list of one or more potential recipients may be presented to the user on the particular source and/or application the user is using to prepare the communication.

At 610, the example method 600 ends.

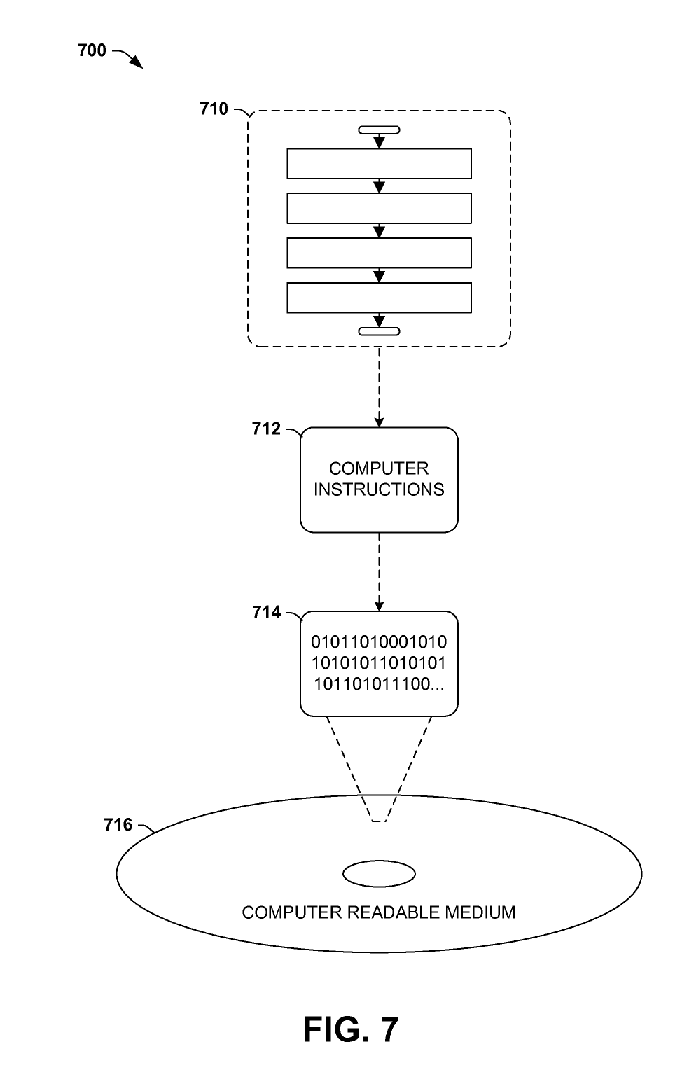

Still another embodiment involves a computer-readable medium comprising processor-executable instructions configured to implement one or more of the techniques presented herein. An exemplary computer-readable medium that may be devised in these ways is illustrated in FIG. 7, wherein the implementation 700 comprises a computer-readable medium 716 (e.g., a CD-R, DVD-R, or a platter of a hard disk drive), on which is encoded computer-readable data 714. This computer-readable data 714 in turn comprises a set of computer instructions 712 configured to operate according to one or more of the principles set forth herein. In one such embodiment 700, the processor-executable computer instructions 712 may be configured to perform a method 710, such as the exemplary method 600 of FIG. 6, for example. In another such embodiment, the processor-executable instructions 712 may be configured to implement a system, such as at least some of the exemplary system 100 of FIG. 1, for example. Many such computer-readable media 716 may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

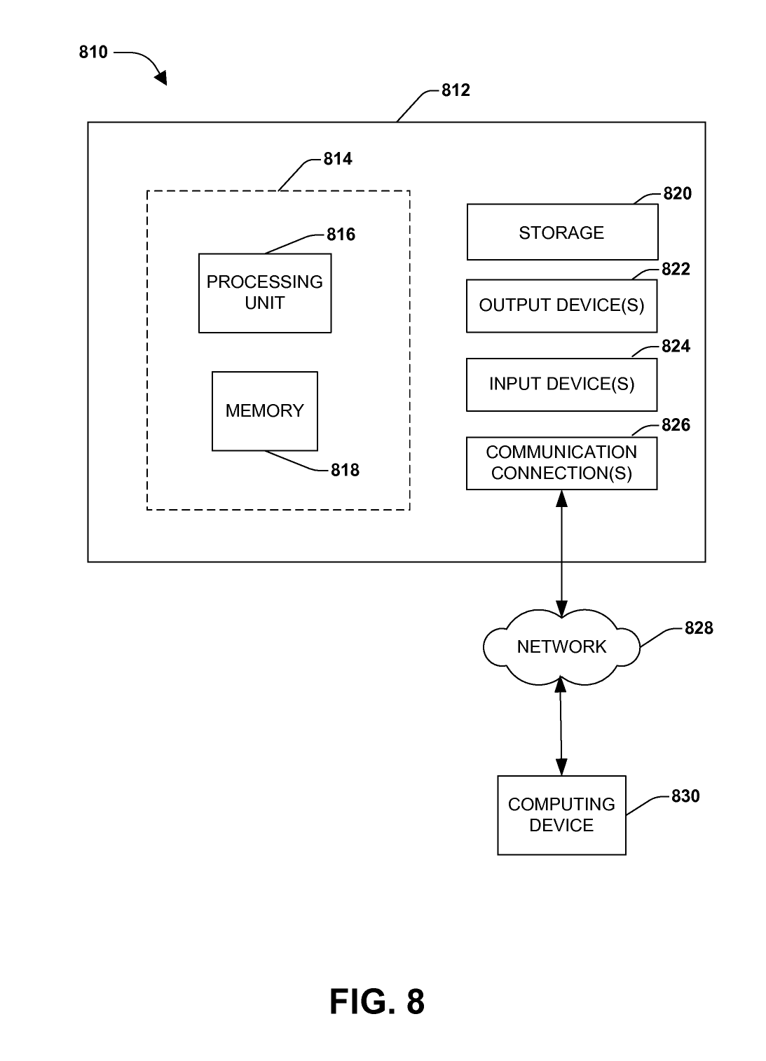

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 810 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via a network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for suggesting one or more potential recipients of a communication a user is preparing, comprising:
identifying one or more potential recipients of the communication based at least in part on something other than a match between one or more characters inputted by a user and one or more corresponding characters of one or more past recipients of communications from the user; and
providing the identified potential recipients to the user for incorporation into the communication the user is preparing.

2. The method of claim 1, one or more potential recipients identified based at least in part on a particular type of communication the user is preparing and a frequency with which the user has that particular type of communication with respective past recipients of communications from the user.

3. The method of claim 1, identifying one or more potential recipients, comprising:
comparing a particular type of communication the user is preparing with information related to the types of communications the user frequently has had with respective past recipients of communications from the user; and
identifying one or more potential recipients whose past communications with the user are of a communication type that corresponds with the particular type of communication the user is preparing.

4. The method of claim 1, one or more potential recipients identified based at least in part upon at least one of a frequency of communication, how recently the user last communicated with a past recipient of communications from the user, and a type of communication the user is preparing.

5. The method of claim 1, identifying one or more potential recipients, comprising:
identifying a communication group associated with two or more past recipients based at least in part upon one or more common past communications with the two or more past recipients.

6. The method of claim 5, comprising
storing the identified communication group as a single entry for later identification as a potential recipient.

7. The method of claim 1, comprising:
identifying as a potential recipient a communication group comprising at least a first past recipient and a second past recipient of communications from the user and not identifying either the first past recipient or the second past recipient individually as potential recipients of the communication that the user is preparing.

8. The method of claim 7, the communication group associated with a communication type corresponding to a communication type of the communication the user is preparing and the first past recipient and second past recipient not individually associated with a communication type corresponding to the communication type the user is preparing.

9. The method of claim 1, comprising analyzing previous behaviors of the user in relation to respective past recipients of communications from the user to identify potential recipients for a communication the user is presently preparing.

10. A system, comprising:
a suggestion engine configured to identify one or more potential recipients of a communication a user is presently preparing, the identification based at least in part on something other than a match between one or more characters inputted by a user and one or more corresponding characters of one or more past recipients of previous communications from the user.

11. The system of claim 10, comprising a database comprising information related to a communication history of the user with the one or more past recipients, the suggestion engine configured to use the information in the database to identify the one or more potential recipients of the communication the user is presently preparing.

12. The system of claim 11, the suggestion engine configured to compare information about the communication the user is presently preparing with the information comprised in the database.

13. The system of claim 12, the suggestion engine configured to compare a communication type of the communication the user is presently preparing with information about a type of communication the user has had with respective past recipients.

14. The system of claim 13, the suggestion engine configured to identify a communication type of the communication the user is presently preparing based at least in part upon at least one of a subject matter of the communication and an attachment to the communication.

15. The system of claim 10, the suggestion engine configured to identify one or more potential recipients from a collection of past recipients based at least in part upon at least one of a frequency with which respective past recipients and the user communicate, how recently respective past recipients and the user have communicated, and a type of communication the user is presently preparing.

16. The system of claim 10, a probability that a past recipient is a potential recipient of the communication the user is presently preparing increasing if the user has had one or more communications with the past recipient that are of a same or similar communication type as a communication type of the communication the user is presently preparing.

17. The system of claim 10, the suggestion engine configured to identify one or more potential recipients before the user inputs one or more characters.

18. The system of claim 10, the suggestion engine configured to create a communication group comprising a plurality of past recipients based at least in part upon the user's previous interactions with the plurality of past recipients.

19. A computer implemented graphic user interface, comprising:
a recipient field for displaying recipients of a communication that is user is presently preparing; and
a potential recipient field for displaying one or more potential recipients of the communication that may be incorporated into the recipient field, the potential recipient field populated with one or more potential recipients that have been identified based at least in part on something other than a match between one or more characters inputted by a user and one or more corresponding characters of one or more past recipients of communications from the user.

20. The computer implemented graphic user interface of claim 19, the potential recipient field displaying one or more potential recipients before the user inputs one or more characters.
